(19) United States
(12) Patent Application Publication
(10) Pub. No.: US 2015/0350736 A1
(43) Pub. Date: Dec. 3, 2015

(54) SOURCE AGNOSTIC CONTENT MODEL

(71) Applicant: TELEFONAKTIEBOLAGET L M ERICSSON (PUBL), Stockholm (SE)

(72) Inventors: Yi Chan, Palo Alto, CA (US); James Stanley, Fremont, CA (US); Kah Loon Liew, Campbell, CA (US); Kumi Akiyoshi, San Francisco, CA (US)

(21) Appl. No.: 14/480,712

(22) Filed: Sep. 9, 2014

Related U.S. Application Data
(60) Provisional application No. 62/004,387, filed on May 29, 2014.

(51) Int. Cl. H04N 21/472; H04N 21/442; H04N 21/488; H04N 21/45

(52) U.S. Cl. CPC H04N 21/47202; H04N 21/4524; H04N 21/442; H04N 21/4882

(57) ABSTRACT

A method in a server device for a source agnostic model is described. The method includes receiving from a client device associated with a subscriber account a selection of a content item. The method also includes selecting a content source that includes the content item in the selection of a content item, wherein the content source is selected based on a priority configuration of content sources in a configuration store, and wherein the priority configuration of content sources prioritizes content sources based at least on the location of the client device and the format that the selected content item stored at each content store is in.

### CLAIM OF PRIORITY

This application claims the benefit of U.S. Provisional Application No. 62/004,387 filed on May 29, 2014. The contents of this document are hereby incorporated by reference herein.

### FIELD

Embodiments of the invention relate to the field of television; and more specifically, to source agnostic content model.

### BACKGROUND

In the contemporary world, content and information may be accessed from a large number of sources. This situation applies to media consumption platforms as well. Consumers now have a large number of choices or sources from which to consume desired content. These sources may include content delivered by cable, satellite, broadcast, video-on-demand, Internet, physical media, and other sources. Each of these sources further includes a variety of different providers all competing for a consumer's business.

Many service providers, such as cable TV, Internet, video-on-demand providers, have systems to present and deliver available content to viewers. Such software systems usually have user interface to display and/or play content on a display device such as a television or other similar devices. Consumers may interact with the system using a control device such as remote control or other companion device to manage and consume desired content.

### BRIEF DESCRIPTION OF THE DRAWINGS

The invention may best be understood by referring to the following description and accompanying drawings that are used to illustrate embodiments of the invention. In the drawings:

FIG. 1 illustrates an exemplary block diagram for a source agnostic content model according to an embodiment of the invention

FIG. 2 illustrates an exemplary flows 202 and 222 for the server device 130 to select a particular content item based on whether a series of content items is serial or non-serial according to an embodiment of the invention.

FIG. 3 illustrates an exemplary detail interface 300 for a source agnostic model according to an embodiment of the invention.

FIG. 4 illustrates an exemplary low-level detail interface 400 for a source agnostic model according to an embodiment of the invention.

FIG. 5 illustrates another exemplary low-level detail interface 400 for a source agnostic model according to an embodiment of the invention.

FIG. 6 is a flow diagram illustrating a method 600 in a server device for a source agnostic model according to an embodiment of the invention.

FIG. 7 illustrates a block diagram for an exemplary data processing system that may be used in some embodiments.

### DESCRIPTION OF EMBODIMENTS

The following description describes methods and apparatus for a source agnostic content model. In the following description, numerous specific details are set forth. However, it is understood that embodiments of the invention may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation. It will be appreciated, however, by one skilled in the art that the invention may be practiced without such specific details. In other instances, control structures, gate level circuits, and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with an embodiment whether or not explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

The operations in the flow diagrams will be described with reference to the exemplary embodiments of the other figures. However, it should be understood that the operations of the flow diagrams can be performed by embodiments of the invention other than those discussed with reference to the other figures, and the embodiments of the invention discussed with reference to these other figures can perform operations different than those discussed with reference to the flow diagrams.

In the current connected world, content and information may be accessed from an immense number of sources. This situation applies to media consumption platforms as well. Consumers now have a large number of choices or sources from which to consume desired content. These sources may include content delivered by cable, satellite, broadcast, video-on-demand, Internet, physical media, and other sources. Each of these sources further includes a variety of different providers all competing for a consumer's business.

Many service providers, such as cable TV, Internet, video-on-demand providers, have systems to present and deliver available content to viewers. These service providers aggregate content from content providers or build/acquire software systems to present and deliver all the available content to viewers. Such software systems usually have a user interface to display content on display devices such as a television, or on other companion devices. Subscribers of the service provider use their remote and/or companion devices to navigate, manage and consume content that they like to watch. Often a service provider will create many different flavors of the same content for business purposes, based on customer consumption patterns, or depending on availability from content providers. They would feed all these into the software system and create a buffet bazaar for TV viewers.

According to embodiments of the invention, a server device receives from a client device associated with a subscriber account a selection of a content item available to the system. This client device may be a set top box, a mobile device, a tablet device, a wearable device, a smart television, a desktop computer, a laptop computer, etc. The system then selects a content source that includes the selected content item. Many content sources may include the content item. The server device includes a configuration store that includes a priority configuration to select which content source to select for the content item. This priority configuration ranks or prioritizes the various content sources based at least upon the location of the client device and the format of the different versions of the selected content item included in the different content sources.

For example, if a user on a client device is at home, the priority configuration may prioritize content sources differently than from when a user is not at home. As another example, if a content source only has a selected content item in a standard definition format, that content source may be prioritized or ranked at a different level for that selected content item than if that selected content item were available in high definition format at that content source.

The content sources may also be ranked by the type of source that they represent. Content may come from different types of sources. Content may be live programming from broadcast channel sources. Some content may come from sources that require subscriptions. Content may come from video on demand systems. It may come from over the top streaming sources (i.e., content that does not arrive via a multi-system operator such as a cable TV provider). It may also come from 3rd party applications or sources. Users can also record live content and store this on a client device associated with their account. Content may also be time-shifted.

Different types of sources may include free video-on-demand (VOD) sources, purchase-required VOD sources, live sources (sources that broadcast content according to a schedule that a user cannot alter, such as a traditional TV channel), and recorded sources, etc. The priority configuration may further prioritize content sources based on other information regarding the sources and the version of the content item available at the source, such as the languages offered for that content item at that source, the bandwidth or capacity for the source, the viewing history for the user, if the user has watched a portion of the content item, etc.

In current systems, the same content comes in different formats and is available through different purchasing, viewing, or recording options. A user may have to access the content using various different interfaces for each content source, and if the content is part of a series, the user may have to access different content sources in order to view the entire series, as each content source may have different portions of the series. If the content items are aggregated into one interface, in current systems, that interface may still present a long list of the same content or scattered pieces of the same content throughout the application. Normally service providers will have a menu system to let users choose and browse to find the content they like to watch, or they can use the search functionality. Users could also walk the EPG grid to find shows. This is still confusing to the user and could hinder the user from consuming the right content and degrade user experience.

Instead, unlike these current systems, the system described herein chooses the best content source for each content item that the user wishes to consume and presents that best version of the content items from the best content source, based on the priority configuration, to the user. The user, through this simplified interface, no longer needs to discover which content source has the content item that the user is looking for. If the content item is part of a series of items, these items are be selected from the content sources that have the item available and are seamlessly presented to the user in an interface as a single series without the user having to concern him or herself with which source each content item might be arriving from.

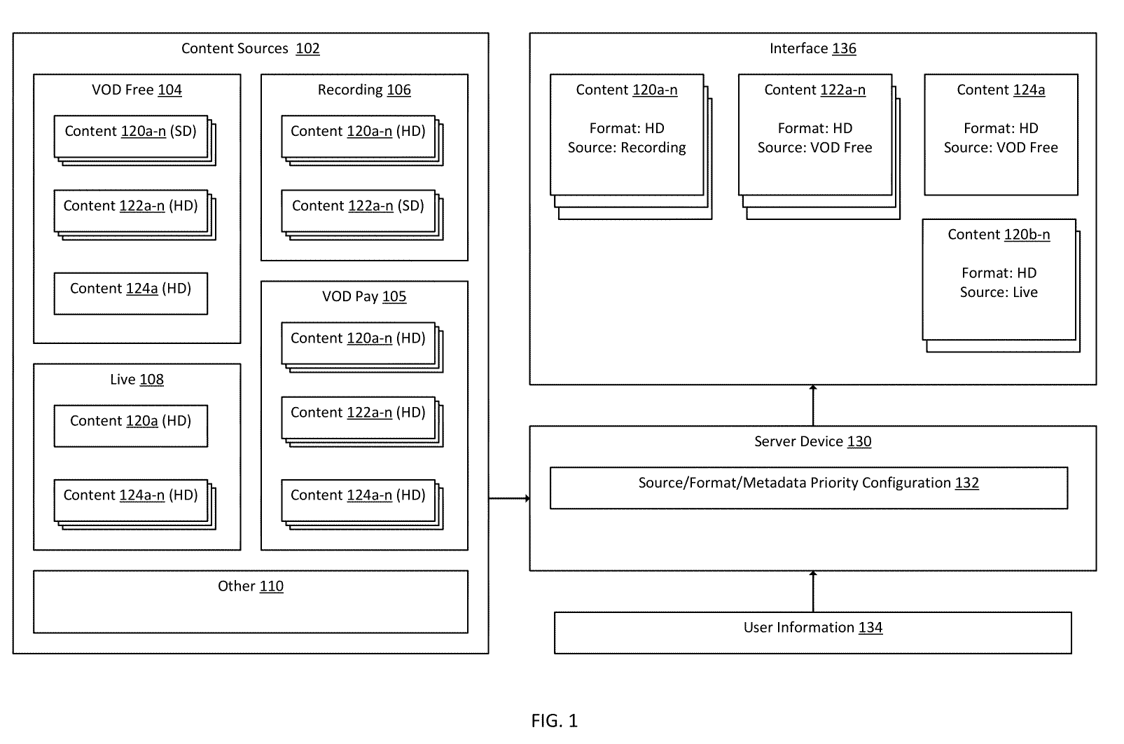

FIG. 1 illustrates an exemplary block diagram for a source agnostic content model according to an embodiment of the invention. The system includes content sources 102, server device 130, priority configuration 132, user information 134, and interface 136 with various content items.

User information 134 is sent to the server device 130 via a client device (not shown). The client device may be any device capable of communicating with the server device 130 through a network. In some embodiments, the client device may be a set top box, a mobile device, a tablet device, a wearable device, a smart television, a computer, a laptop computer, etc. The client device may include an application that allows the system to collect the user information 134, and this application may utilize the capabilities of the client device to collect this information. For example, the client device may be a mobile device, and the application may be able to utilize a location sensor, such as a GPS sensor, to determine the location of the user of the mobile device and send this as user information 134 to the server device 130. Server device 130 may be a combination of hardware and software, and may be owned or operated by the provider of the system, such as a cable TV operator.

Some content sources 102 are VOD sources. VOD sources include a library of different content that may be retrieved at any time by server device 130 or by a client device.

Content sources 102 include VOD free sources 104. These sources include various video on demand sources from which the requested content is free or has already been purchased by the subscriber. These sources may include an Internet content subscription service (e.g., Netflix® of Netflix, Los Gatos, Calif.), an Internet video service (e.g, Youtube® of Google, Mountain View, Calif.), purchased content from a content marketplace service (e.g., iTunes® of Apple, Cupertino, Calif.), the content library of a subscribed content channel (e.g., HBO GO® of Time Warner, New York, N.Y.), the content library of a television operator (e.g., XFINITY® of Comcast, Philadelphia, Pa.), cloud storage platforms for a user's owned content, local network content repositories, etc.

Content sources 102 include VOD pay sources 105. These sources include various video on demand sources from which the requested content is not free and requires payment to retrieve. Some of these sources may provide access to the requested content item for different lengths of time based on the amount of payment made to access the content. These sources may include pay-per-view sources, unpurchased content from a content marketplace service, content from an unsubscribed content channel, content that may be purchased through an Internet content service, etc.

Content sources 102 include live sources 108. Live sources 108 are not content libraries where a user may select to play a particular content item. Instead, live sources 108 play content according to a schedule. This scheduled content may include content that is being played back in real time as it is recorded. Live sources 108 may also include content that was produced and recorded previously but is being played for the first time at that live source 108. Live sources 108 may also include content that has been played before but is being played back again as a repeat or re-run. Some of the content items from a live source 108 may also be available through other sources, such as VOD free sources 104 and VOD pay sources 105. However, due to licensing between different content providers, some content items may only be available through a live source 108. This means that this content may only be played or consumed when it is schedule to be played at that live source 108.

Content sources 102 may also include recording sources 106. These are sources that have recorded or copied content items to a connected storage medium. These sources may include set top boxes, digital video recorders (DVRs), computer devices, mobile devices, cloud recording platforms, video recording devices, portable media devices, and other devices that are able to record or copy content items to a connected storage. The recording source 106 may record or copy shows from the other content sources 102. For example, a recording source 106 may be a DVR that has been configured to record a content item from a live source 108. The recording source 106 will record the content item and store it in a local storage media for later retrieval. The content item that has been stored need not be identical to the content item as it was played from the original source, and may be modified. For example, the recording source 106 may store a lower quality version of the content item in order to lower the storage space costs of storing the content item. The recording source 106 may be part of the client device (not shown).

Although these broad categories of content sources 102 have been described above, the server device 130 is not limited to acquiring content items from these sources alone. Content items may also be acquired from other sources 110, such as a user's cloud storage, an imaging device, a user's mobile device, a wireless media storage platform, a user device such as a such as a web camera or a head mounted display that streams live content, interactive content source such as a video game, etc.

Content items, such as content 120, 122, and 124, may be stored or provided by the content sources 102 with a variety of metadata information and in a variety of formats. Metadata information describes various attributes and provides additional information related to corresponding content items. Examples of metadata information for content items include length, genre, description, transcript, subtitles, user ratings, links to additional related content, credits list, production information, whether the content items is part of a series, and whether a series is serial or non-serial. Metadata may also describe the format of the content item. A content item may come in a variety of formats options, such as high definition, standard definition, ultra high definition, encoding format, sound channel format, aspect ratio, 3D or 2D, resolution, bit rate, etc.

Server device 130 may receive a request for a selected content item from a client device associated with the subscriber account of a user for a selected content item. In some embodiments, instead of receiving a request for a content item, the server device 130 selects all the available content items and provides this information to the client device. In some embodiments, server device 130 receives a selection for a content series. In such a case, server device 130 determines that all the content items in that series as selected content items.

Each selected content item may be available from multiple content sources 102. When a selected content item is available from multiple content sources 102, the server device 130 selects the version of the content item from the best content source 102 based on priority configuration 132. Priority configuration 132 includes one or more rules that server device 130 consults or reads to determine which content source 102 to retrieve the content item from based on the metadata and format information for the content item at each source and the type of the content source as described above, in addition to user information 134.

User information 134 includes various information about the user, subscriber account, or client device accessing the content items via server device 130. This information may be provided dynamically by client device and/or the application executing on client device. This information may also be provided interactively via a prompt to the user using the client device to access the content items. This information may also be provided via profile data, consumption statistics, and other information associated with the subscriber account. Information provided by the client device may include the GPS location of the device, whether the device is in a home location or a non-home location, the resolutions supported by the device, the bandwidth available at the device to deliver the content items, the number of sound channels supported by the device, the aspect ratio of the device, the current time of day and time zone of the device, the decoding capabilities supported by the device, the user interface capabilities of the device, the input abilities of the device, whether a headphone is being used, etc.

Information provided by the user may be provided through prompts to the user when the user accesses the system via the client device and may include information such as age, viewing distance from device, languages understood, hearing ability (e.g., for closed caption), the cost, if any, of sending data through the network connected to the client device, the location of the user, whether the user prefers 3D, the aspect ratios preferred by the user, whether the user is using a headphone, etc.

Information provided by a profile data associated with the subscriber account may include age, gender, home address, viewing preferences, genre preferences, language preferences, subscribed content sources, aspect ratio preferences, video format preferences, etc. Information provided by consumption statistics associated with the subscriber account may include previous consumption habits, language preferences, subtitle or closed caption preferences, client devices used, genre viewing habits, rating history of content, times of day and times of week that consumption takes place, fast forward or skipping habits, pausing and resuming habits, available bandwidth statistics, etc.

In some embodiments, the rules in priority configuration 132 are set by an administrator. The administrator may set rules based on available user information categories to instruct the server device to prefer certain content sources over other content sources based on the rules after gathering user information. The administrator may set rules for the entire subscriber base, or for groups of subscribers or individual subscribers.

In some embodiments, the rules are determined automatically by server device 130 based on an analysis of a subscriber account's viewing habits. For example, a subscriber account may typically watch content in a certain language, such as Mandarin. The server device 130 may then create a rule in priority configuration 132 to prefer content sources that offer the selected content item in that language.

Based on the rules in the priority configuration 132, the server device 130 retrieves the content item from a content source with the highest priority value and causes the client device to display this content item from the highest priority content source to the user in interface 136. The interface 136 may be integrated into the client device or may be connected to the client device. The interface 136 is a unified interface such that the user does not need to search through various different interfaces in order to discover the content item of interest to the user. Instead, the available content items from available content sources are presented to the user in unified interface 136. Furthermore, the highest priority, or “best”, version of each content item is presented to the user in interface 136, ensuring that the user may be able to watch a desirable version of each content item.

In an exemplary embodiment, for a selected content item, the server device 130 determines the location of the user via user information 134 and the format of the content item in the various content sources 102 to determine the priority of content sources 102 to retrieve the content item from. If the server device 130 determines through user information 134 that the user is at the home location, the priority rules may be set as follows in Table 1 based on the type of the content source and the high definition (HD) or standard definition (SD) format of the selected content item at the content source.

TABLE 1

| | HD | SD |
|---|---|---|
| VOD Free | 1 | 3 |
| VOD Pay | 7 | 8 |
| Recording | 2 | 4 |
| Live | 5 | 6 |

In the above Table 1, for the selected content item, the server device 130 queries the content sources to determine whether they have the content item in question. The server device then checks the format data for the content item at each source. By consulting the priority configuration for the in-home configuration as shown in Table 1, the server device 130 is able to determine which content source it should retrieve the content item from. The sources are ranked from 1 being the highest priority and 8 being the lowest priority. Thus, if the same content item is available in the HD format from a VOD free source and in an HD format from a VOD Pay source, the server device 130 will prefer the VOD free source and retrieve the content item from that source because the VOD free source has a priority of 1 compared to the priority value of 7 for the VOD pay source.

The exemplary priority configuration described in Table 1 is shown as an exemplary configuration in FIG. 1. A user has accessed the system from a home location. Three exemplary content items 120, 122, and 124 are shown. Furthermore, each content item is part of a series. For example, a series could be an album of songs or a television series with multiple episodes and seasons. Thus, three exemplary content item series 120a-n, 122a-n, and 124a-n are shown. These content items are available in the different sources and in different formats. For content series 120a-n, the entire series is available at a VOD free source 104 in SD format, at a recording source 106 in HD, at a VOD pay source 105 in HD. A single content item from the series, 120a, is also available at a live source 108. According to the priority configuration in Table 1, the recording source HD content is set at a priority of 2, while the VOD free SD content is set at a priority of 3, the live HD content at a priority of 5, and the VOD pay HD content at a priority of 7. Thus, the source with the highest priority is the recording source that includes the content series 120 in HD format. The content series 120 is thus sourced from the recording source 106 and displayed to the user via an interface 136 on a client device.

Content series 122 is available from a VOD free source 104 in HD, from a recording source 106 in SD, and from a VOD pay source 105 in HD. These correspond to priority values of 1, 4, and 7, respectively. Thus, the source that has the highest priority of 1 for that particular content, VOD free 104, is used to retrieve the content series 122 from and that content series is displayed to the user at interface 136.

A single content item 124a in content series 124 is available from a VOD free source 104 in HD format. The entire series is available from a live source 108 in HD format, and available from a VOD pay source 105 in HD format. According to the exemplary priority configuration in Table 1, for the single content item 124a, the VOD free source 104 has the highest priority, and thus content item 124a is selected from the VOD free source 104 and displayed in interface 136. For the remaining items 124b-n in the series, the live source 108 has the next priority rank of 5. Thus, the remaining items are selected from the live source 108 and displayed in interface 136 as shown.

Note that since the items are retrieved from the live source 108, a user may only consume these items based on the schedule set by the live source 108. If the user misses an item in the series by missing the schedule, then the server device 130 determines that the VOD pay source 105 is the only source that has the missed content item. The server device may then present that source to the user. As the user would need to pay to watch the content on the VOD source, the system may additionally present a payment interface to the user to purchase the content or a note to the user that the content requires payment. In some embodiments, the server device 130 may determine that the user is interested in the series but also knows that the user may not be able to view the items in the series when they are played by the live source 108, due to previous consumption habits. Based on the habits, or based on previously configured settings, the server device may instruct a recording source 106 such as a DVR to record the content items from the live source 108 so that the user may have an opportunity later to consume those content items.

In another exemplary embodiment, the server device may include additional priority configuration information 132 for the situation where a user is using a client device from a non-home location. The priority configuration is similar in this exemplary embodiment to Table 1 and is shown below in Table 2.

TABLE 2

| | HD | SD |
|---|---|---|
| VOD Free | 1 | 2 |
| VOD Pay | 3 | 4 |
| Recording | 5 | 6 |
| Live | 7 | 8 |

The priority configuration in Table 2 may be set by an administrator or may be determined automatically by server device 130 based on user information 134 or other data. Compared to the home location priority configuration of Table 1, the exemplary non-home priority configuration of Table 2 places recording and live sources at a lower priority. This may be due to a concern that these sources may need to be delivered to the client device from the subscriber's home through the subscriber's network connection, which may not be adequate to deliver the content at an acceptable performance. For example, for a content item at a recording source at the home location may have to be sent to the client device which is not at the home location. This may result in inconsistent and degraded delivery of the content item due to the limited bandwidth of the subscriber's home Internet connection. Instead VOD sources are set to a higher priority, as content from these sources are typically delivered via the high bandwidth connections of a VOD provider, and are less likely to suffer from performance degradation in the delivery of the content item to the non-home location.

Turning to the exemplary list of content items in FIG. 1, instead of delivering content series 120 from the recording source 106, the server device may instead request the SD version of content series 120 from the VOD free source 104. Instead of requesting the content series 124 from the live source 108, the server device 130 may instead request the content from VOD pay source 105.

Note that while FIG. 1 displays an arrow from the content sources 102 to server device 130, the content items in the content sources do not need to be transferred via server device 130 to interface 136 on the client device. Instead, the server device 130 may arrange images, thumbnails, and other descriptors for the content items to be displayed on the interface 136 on the client device, and the server may instruct the client device to directly retrieve the content items from their corresponding content sources. This allows the client device to bypass the server device when playing the content and reduce the resources required to transfer the content to be displayed on client device.

Although the exemplary embodiment shown above consider user location and content format when determining which content source to select the content item from, in some embodiments different combinations of content metadata, format data, and user information are used to determine the priority configuration of which content source to retrieve a selected content item from. In some embodiments, the language that the subscriber typically uses to play content is used to rank those content sources which include that content item in the preferred language higher. In some embodiments, the aspect ratio, sound channel support, or resolution of the client device is used to rank higher those sources that have the selected content in a compatible format. In some embodiments, the connection bandwidth and/or speed between the client device and the content source is used to rank those sources which are faster or can deliver the content without significant delay. In some embodiments, a content source is ranked higher based upon a subscriber account's frequent selection of that content source. In some embodiments, a user's preference of whether he or she wishes to watch 3D content ranks the appropriate content source higher. In some embodiments, a user has indicated that he or she is hearing impaired, and those content sources which include subtitles for the selected content item may be ranked higher. In some embodiments, whether a series of content items is serial or non-serial can change the priority configuration such that if a series is serial, the sources which have the next content item in the series that has not yet been consumed are ranked higher than those sources which do not. Combinations of these and other embodiments with different ranking considerations for the priority configuration 132 may be considered by the server device 130 in determining which content source receives a higher priority for a selected content item and which receives a lower priority.

In some cases for each of the types of content sources 102, there may be many sources that fit that type. For example, a subscriber account may have subscribed to multiple VOD free sources 104. In such a scenario, the server device 130 may first determine whether each one of these sources includes the selected content item, and if more than one source includes the selected content item, these individual sources may be ranked based upon some of the factors listed above, including user information, format information, and content metadata.

In some embodiments, the user information, available content sources, available content items, and other factors are constantly changing. The server device 130 continuously monitors the changes and may modify the content item displayed in the interface 136 to match the changing situation.

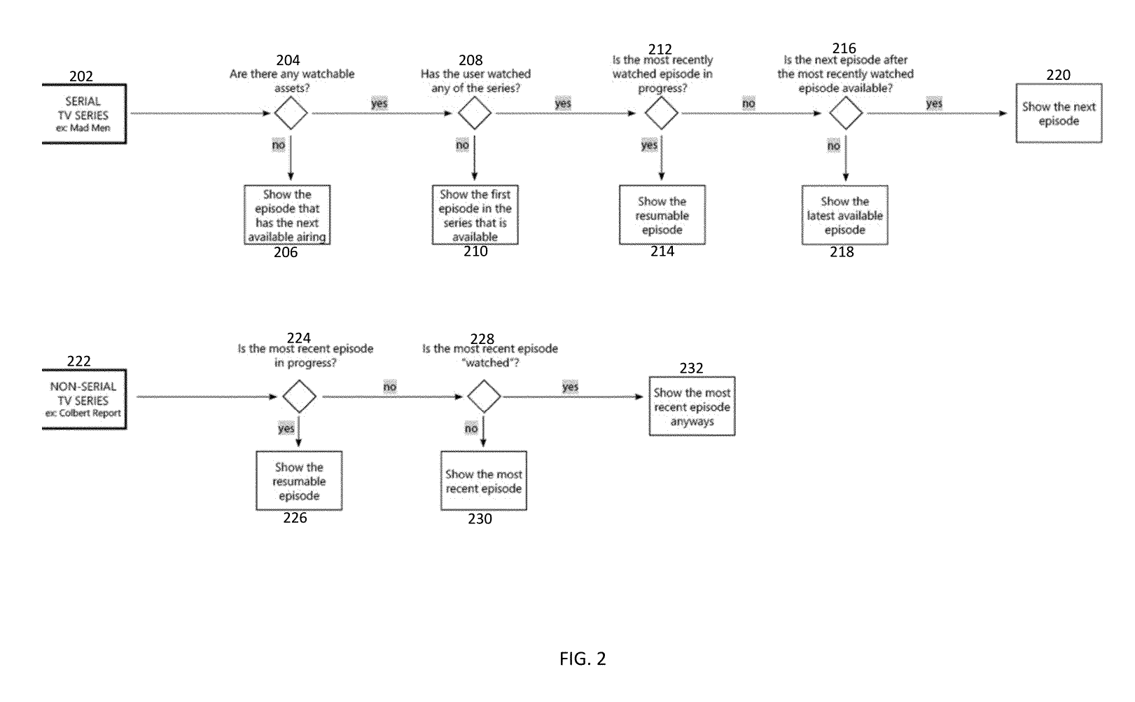

FIG. 2 illustrates an exemplary flows 202 and 222 for the server device 130 to select a particular content item based on whether a series of content items is serial or non-serial according to an embodiment of the invention. Some content items, as described previously, are part of series. The server device 130 may receive from a user a selection of one of the content items in a series or a selection of the entire series for consumption. When the server device 130 receives such a selection, it may need to determine which content item in the series to select and display to the user, in addition to determining which content source to retrieve the content item from. This process may be done using the processing logic described in FIG. 2. In some embodiments, the rules in the flow may be configured in priority configuration 132.

Some series have a particular order in which the content items of these series should optimally be consumed in. These series may be referred to as serial. For these types of series, in some embodiments, flow 202 includes the processing logic for server device 130 to determine which content item in the series to select. At 204, the server device determines whether there are any immediately watchable or consumable assets or content items. Thus, the server device determines if any content sources include any of the content items of the particular series. If no assets are available, at 206, the server device 130 may attempt to show the next content item in the series that will be played by a live source 108. If there are available assets, flow moves to 208, where the server device 130 determines if the user has consumed any items in the series based on user information, such as user information 134. If the user has not consumed any content items in that series, at 210, the server device 130 causes the client device to show to the user the first available content item in the series.

If the user has consumed some content items in the series, then flow moves to 212 where the server device 130 determines whether the user has consumed a portion or part of a content item but not all of it. For example, if a user has watched half of a program, and then paused it, that user has consumed part of the content item. If the user has consumed a portion of a content item in the series, flow moves to 214 where the server devices 130 causes the client device to resume the playing of the content item at the point where the user stopped consuming it previously. If the user has not partially consumed a content item in the series, then flow moves to 216 where the server device 130 determines if the next content item in the series is available. This next content item is the content item that is designated in the series to be consumed after a most recently consumed content item in the series. If the next item is not available, at 218 the server device 130 causes the client device to the last content item in the series that is available. Otherwise, at 220, server device 130 causes the client device to show this next content item.

In some cases, a content item is part of a series that does not have an order with which the items should be watched. These series are non-serial. For these series, in some embodiments, flow 222 includes the processing logic for server device 130 to determine which content item in the series to select. At 224, the server device 130 determines whether the most recently available content item of the series is being played by a live source 108. If this is the case, flow proceeds to 226 where server device 130 causes that content item to be shown on the client device. The content item may have already begun broadcasting by the live source 108. In this case, the client device begins playback from the current broadcast point.

If the most recent content item is not being played, flow proceeds to 228 where the server device determines whether the most recent content item in the series has been consumed by the subscriber account. If not, flow proceeds to 230 where the most recent content item is caused to be shown on the client device. Otherwise, at 232, in some embodiments, the server device causes the client device 130 to show an older content item in the series that the subscriber account has not consumed previously. In some embodiments, the server device 130 causes the client device to show the most recent content item regardless of whether the subscriber account has consumed that most recent item. This may occur when the subscriber account has consumed all available content items in that series.

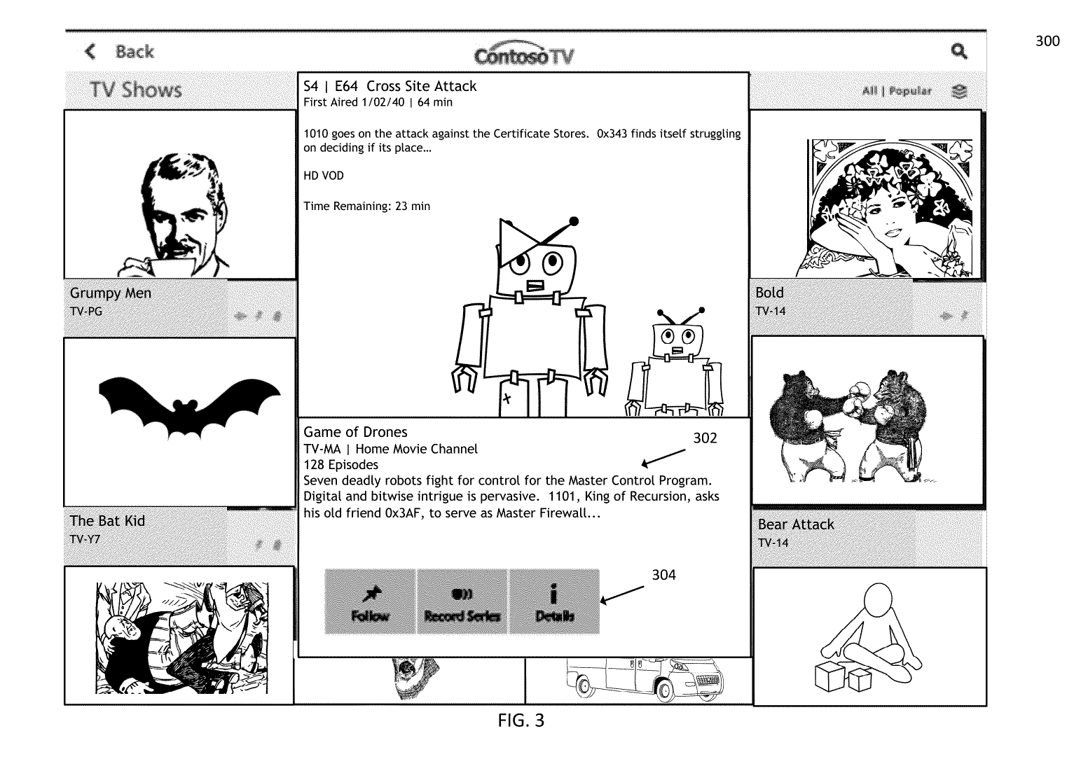

FIG. 3 illustrates an exemplary detail interface 300 for a source agnostic model according to an embodiment of the invention. As described previously, the server device 130 may cause a client device to display content items selected from content sources according to rules in the priority configuration in an interface 136. In some embodiments, the interface 136 may include detail interface 300. When a user finds a content item of interest, a popup mid-modal detail, such as popup interface 302, is shown to the user. The highest ranked content item from the content source selected based on the priority configuration is displayed on this popup 302, hiding versions of the content item from other sources. If the user is satisfied with this content item, he or she can interact with the interface 300 to play the content item. If not, in some embodiments, the server device 130 may receive a message from client device indicating that the user has interacted with detail action button 304 in mid-modal popup 302, which causes the server to cause client device to display to the user a low-level detail page where all the different versions of the content item are listed in a filmstrip interface, with the priority content item at the far left.

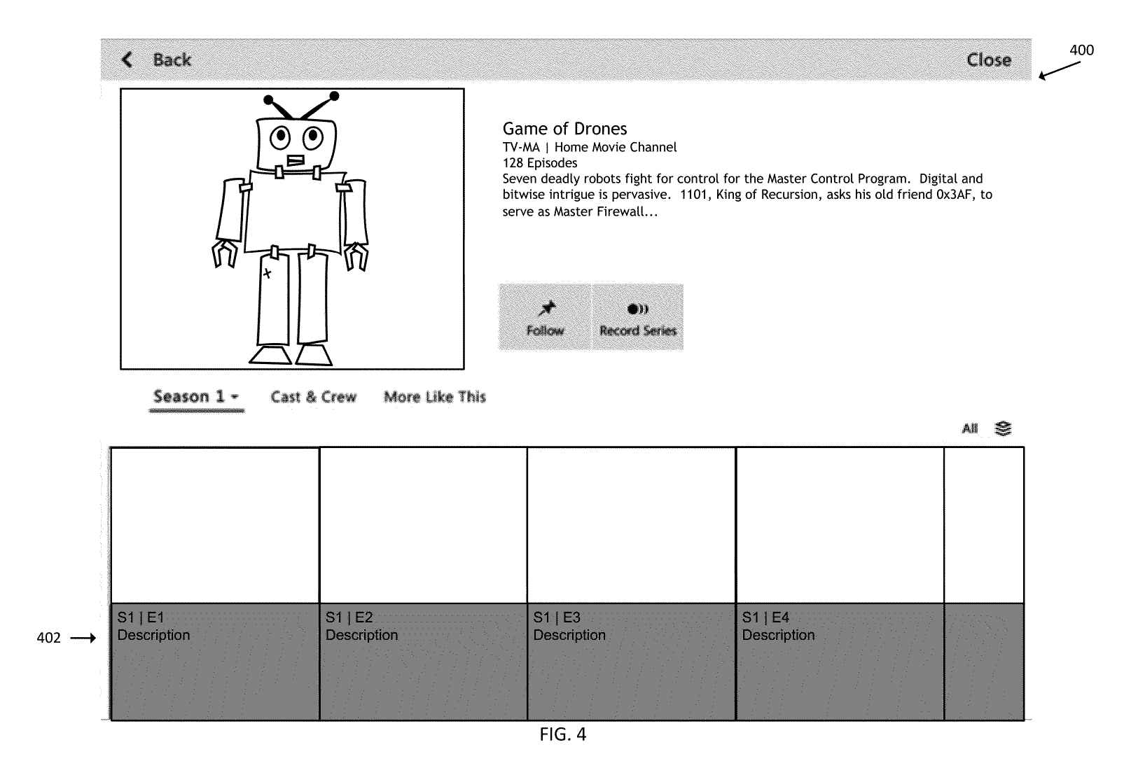

FIG. 4 illustrates an exemplary low-level detail interface 400 for a source agnostic model according to an embodiment of the invention. As described above, in some embodiments, a user may interact with a detail action button. In some embodiments, when the server device 130 receives an indication of an interaction with the detail action button, the server device instructs the client device to display low-level detail interface 400. In the case where the selected content item is part of a series, in some embodiments, the content items in the series are shown in a filmstrip view 402 in descending order according to the priority rank of that content item, with the content item with the highest priority at the far left. The filmstrip view 402 may only display the highest priority configuration ranked version of each content item in the series. Alternatively, the filmstrip view 402 may also show each version of each content item in the series from the different content sources, ranked by priority. In some embodiments, instead of showing each version of each content item, an additional details interface may be shown when the user selects one of the content items in the series. This additional details interface may display the different content sources from which that content item is available from, ranked by the priority configuration.

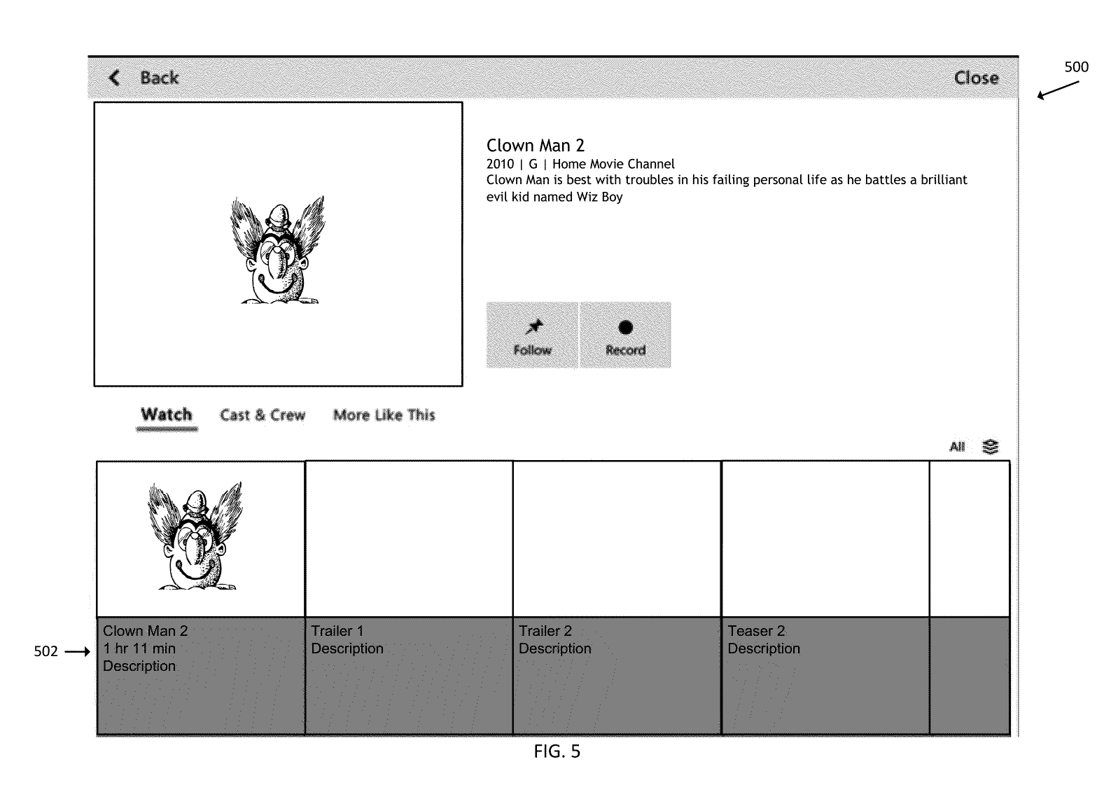

FIG. 5 illustrates another exemplary low-level detail interface 400 for a source agnostic model according to an embodiment of the invention. In some cases, the content item is not part of a series. For example, the content item may be a movie. In such a case, when the user interacts with the detail action button for that content item, the server device 130 causes the client device to display a low-level detail interface 500 with filmstrip view 502. In filmstrip view 502, the priority content item is shown on the far left followed by content items of the next best option as ranked by the priority configuration to the right. In some embodiments, in addition to including the selected content item, the filmstrip view 502 also includes related content items to the selected content items, such as a trailer for a movie, etc.

Although the above descriptions describe a server device 130 causing the client device to display the interface 136, in some embodiments an application on the client device is able to directly generate the interface, perform the priority calculation, and perform the various methods described above for the server device 130.

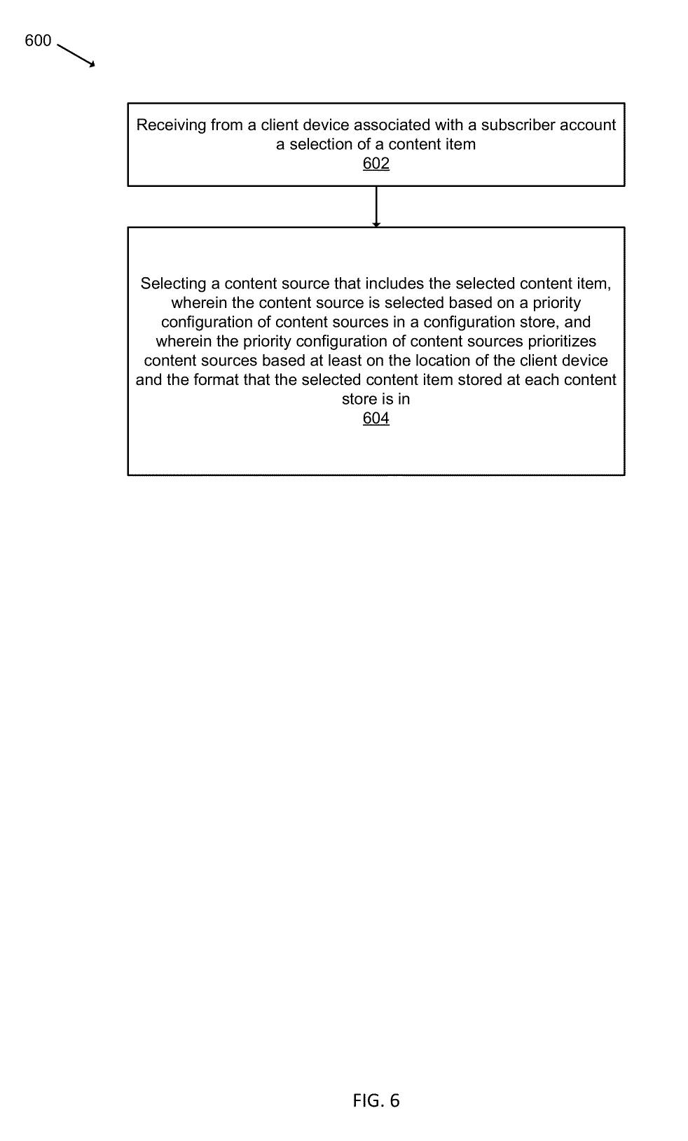

FIG. 6 is a flow diagram illustrating a method 600 in a server device for a source agnostic model according to an embodiment of the invention. In some embodiments, this method is performed by server device 130. At 602, the method includes receiving from a client device associated with a subscriber account a selection of a content item.

At 604, the method includes selecting a content source that includes the selected content item, wherein the content source is selected based on a priority configuration of content sources in a configuration store, and wherein the priority configuration of content sources prioritizes content sources based at least on the location of the client device and the format that the selected content item stored at each content store is in. In some embodiments, the priority configuration is priority configuration 132.

The server device may further provide these selected content items to the client device, either for the client device to retrieve directly from the server device, or for the client device to retrieve directly from the content sources. In some embodiments, the server device presents the selected content items in an interface from which the client device can retrieve the selected content items from.

Although the flow diagrams in the figures show a particular order of operations performed by certain embodiments of the invention, it should be understood that such order is exemplary (e.g., alternative embodiments may perform the operations in a different order, combine certain operations, overlap certain operations, etc.).

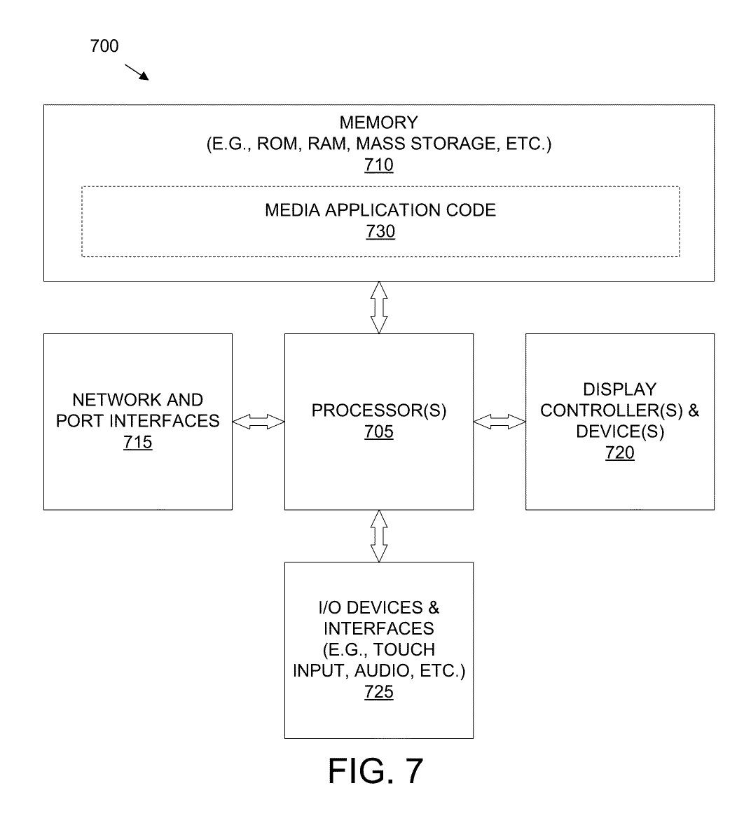

FIG. 7 illustrates a block diagram for an exemplary data processing system 700 that may be used in some embodiments. Data processing system 700 includes one or more microprocessors 705 and connected system components (e.g., multiple connected chips). Alternatively, the data processing system 700 is a system on a chip. One or more such data processing systems 700 may be utilized to implement the functionality of the client devices, server computing devices 130, and/or content servers for content sources 102, as illustrated in FIG. 1.

The data processing system 700 includes memory 710, which is coupled to the microprocessor(s) 705. The memory 710 may be used for storing data, metadata, and programs for execution by the microprocessor(s) 705. For example, the depicted memory 710 may store media application code 730 that, when executed by the microprocessor(s) 705, causes the data processing system 700 to perform the operations described herein. The memory 710 may include one or more of volatile and non-volatile memories, such as Random Access Memory (“RAM”), Read Only Memory (“ROM”), a solid state disk (“SSD”), Flash, Phase Change Memory (“PCM”), magnetic storage, or other types of data storage. The memory 710 may be internal or distributed memory. In some embodiments, a portion or all of the media application code 730 is stored on an external cloud device.

The data processing system 700 may also include a display controller and display device 720 that provides a visual user interface for the user, e.g., GUI elements or windows. The display device 720 may also display various media content to the user. The data processing system 700 also includes one or more input or output (“I/O”) devices and interfaces 725, which are provided to allow a user to provide input to, receive output from, and otherwise transfer data to and from the system. These I/O devices 725 may include a mouse, keypad, keyboard, a touch panel or a multi-touch input panel, camera, optical scanner, network interface, modem, other known I/O devices or a combination of such I/O devices. The touch input panel may be a single touch input panel which is activated with a stylus or a finger or a multi-touch input panel which is activated by one finger or a stylus or multiple fingers, and the panel is capable of distinguishing between one or two or three or more touches and is capable of providing inputs derived from those touches to the processing system 700. The I/O devices and interfaces 725 may also include a connector for a dock or a connector for a USB interface, FireWire, Thunderbolt, Ethernet, etc., to connect the system 700 with another device, external component, or a network. Exemplary I/O devices and interfaces 725 also include wireless transceivers, such as an IEEE 802.11 transceiver, an infrared transceiver, a Bluetooth transceiver, a wireless cellular telephony transceiver (e.g., 2G, 3G, 4G), or another wireless protocol to connect the data processing system 700 with another device, external component, or a network and receive stored instructions, data, tokens, etc. In some embodiments, these various components will be provided as a system on a chip (SoC). It will be appreciated that one or more buses may be used to interconnect the various components shown in FIG. 7.

For example, the data processing system 700 may be a personal computer (PC), tablet-style device, a personal digital assistant (PDA), a cellular telephone (e.g., smartphone), a Wi-Fi based telephone, a handheld computer which may optionally include a cellular telephone, a media player, an entertainment system, a handheld gaming system, a wearable computing device (e.g., smartwatch, digital eyewear), or devices which combine aspects or functions of these devices, such as a media player combined with a PDA and a cellular telephone in one device. In other embodiments, the data processing system 700 may be a network computer, server, or an embedded processing device within another device or consumer electronic product. As used herein, the terms computer, system, device, processing device, and “apparatus comprising a processing device” may be used interchangeably with the term data processing system 700 and include the above-listed exemplary embodiments.

It will be appreciated that additional components, not shown, may also be part of the system 700, and, in certain embodiments, fewer components than that shown in FIG. 7 may also be used in a data processing system 700. For example, in some embodiments where the data processing system 700 is a set top box, the set top box may include components such as a digital broadcast receiver (e.g., satellite dish receiver, radio frequency (RF) receiver, microwave receiver, multicast listener, etc.) and/or a tuner that tunes to appropriate frequencies or addresses of received content. For example, a tuner may be configured to receive digital broadcast data in a particularized format, such as MPEG-encoded digital video and audio data, as well as digital data in many different forms, including software programs and programming information in the form of data files. As another example, the set top box may include a key listener unit to receive authorization and/or session keys transmitted from a server. The keys received by listener unit may be used by cryptographic security services implemented in a protection mechanism in the set top box to enable decryption of the session keys and data.

The set top box may further include components such as an encryption and/or decryption integrated circuit to decrypt incoming signals from the network and encrypt outgoing media signals to a display device. The digital set top box may also include a receptacle to receive an encryption key store that includes the encryption keys used to decrypt incoming signals. The set top box may further include a Wi-Fi, Bluetooth, infrared, or other input method to receive input from a controller device such as a keyboard, a remote, a mobile application on a smartphone, etc.

It will be apparent from this description that aspects of the inventions may be embodied, at least in part, in software. That is, the computer-implemented methods may be carried out in a computer system or other data processing system in response to its processor or processing system executing sequences of instructions contained in a memory, such as memory 710 or other non-transitory machine-readable storage medium. The software may further be transmitted or received over a network (not shown) via a network and/or port interface 715. In various embodiments, hardwired circuitry may be used in combination with the software instructions to implement the present embodiments. Thus, the techniques are not limited to any specific combination of hardware circuitry and software, or to any particular source for the instructions executed by the data processing system 700.

An electronic device, such as the client devices, server computing devices, and/or content servers described herein, stores and transmits (internally and/or with other electronic devices over a network) code (which is composed of software instructions and which is sometimes referred to as computer program code) and/or data using machine-readable media, such as non-transitory machine-readable media (e.g., machine-readable storage media such as magnetic disks, optical disks, read only memory, flash memory devices, phase change memory) and transitory machine-readable transmission media (e.g., electrical, optical, acoustical or other form of propagated signals—such as carrier waves, infrared signals). Thus, an electronic device (e.g., a computer) includes hardware and software, such as a set of one or more processors coupled to one or more non-transitory machine-readable storage media (to store code for execution on the set of processors and data) and a set or one or more physical network interface(s) to establish network connections (to transmit code and/or data using propagating signals). One or more parts of an embodiment of the invention may be implemented using different combinations of software, firmware, and/or hardware.

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A method in a server device, comprising:
receiving from a client device associated with a subscriber account a selection of a content item; and
selecting a first content source that includes a first version of the selected content item, wherein the first content source is one of a plurality of content sources that include versions of the selected content item, wherein the first content source is selected based on a priority configuration of the plurality of content sources in a configuration store, and wherein the priority configuration of the plurality of content sources prioritizes those content sources based at least on a location of the client device and a format of the different versions of the selected content item included in the plurality of content sources.

2. The method of claim 1, further comprising causing the first version of the selected content item from the selected first content source to be played on the client device.

3. The method of claim 1, wherein the plurality of content sources include at least one of a live source, a free video-on-demand source, a non-free video-on-demand source, and a recording source.

4. The method of claim 1, wherein the priority configuration further prioritizes content based on at least one of a language of the different versions of the selected content item included at the plurality of content sources, bandwidth of the plurality of content sources, sound channel format of the different versions of the selected content item at the plurality of content sources, subtitle selection of the different versions of the selected content item at the plurality of content sources, content consumption history of the subscriber account, playback capabilities of the client device, and consumption preferences of the subscriber account.

5. The method of claim 1, further comprising:
receiving an indication to display a set of one or more other content sources, other than the selected first content source, that include a version of the selected content item;
sending a message to the client device to cause the client device to display the set of other content sources according to the priority of each content source as determined by the priority configuration.

6. The method of claim 1, further comprising:
responsive to determining that the selected content item is part of a series of related content items, selecting a first content item in the series that has not been consumed by the user yet as the first version of the selected content item

7. A non-transitory computer-readable storage medium having instructions stored therein, wherein the instructions, when executed by a processor of a server device, cause the processor to perform operations comprising:
receiving from a client device associated with a subscriber account a selection of a content item; and
selecting a first content source that includes a first version of the selected content item, wherein the first content source is one of a plurality of content sources that include versions of the selected content item, wherein the first content source is selected based on a priority configuration of the plurality of content sources in a configuration store, and wherein the priority configuration of the plurality of content sources prioritizes those content sources based at least on a location of the client device and a format of the different versions of the selected content item included in the plurality of content sources.

8. The non-transitory computer-readable storage medium of claim 7, further comprising causing the first version of the selected content item from the selected first content source to be played on the client device.

9. The non-transitory computer-readable storage medium of claim 7, wherein the plurality of content sources include at least one of a live source, a free video-on-demand source, a non-free video-on-demand source, and a recording source.

10. The non-transitory computer-readable storage medium of claim 7, wherein the priority configuration further prioritizes content based on at least one of a language of the different versions of the selected content item included at the plurality of content sources, bandwidth of the plurality of content sources, sound channel format of the different versions of the selected content item at the plurality of content sources, subtitle selection of the different versions of the selected content item at the plurality of content sources, content consumption history of the subscriber account, playback capabilities of the client device, and consumption preferences of the subscriber account.

11. The non-transitory computer-readable storage medium of claim 7, the method further comprising:
receiving an indication to display a set of one or more other content sources, other than the selected first content source, that include a version of the selected content item;
sending a message to the client device to cause the client device to display the set of other content sources according to the priority of each content source as determined by the priority configuration.

12. The non-transitory computer-readable storage medium of claim 7, the method further comprising:
responsive to determining that the selected content item is part of a series of related content items, selecting a first content item in the series that has not been consumed by the user yet as the first version of the selected content item.
